(19) United States
(12) Patent Application Publication
(10) Pub. No.: US 2009/0084126 A1
(43) Pub. Date: Apr. 2, 2009

(54) Atmosphere Handling System For Confined Volumes

(76) Inventor: Terry R. Schartel, Berks County, PA (US)

Correspondence Address: DICKSTEIN SHAPIRO LLP, 1825 EYE STREET NW, Washington, DC, 20006-5403, US

(21) Appl. No.: 12/239,008

(22) Filed: Sep. 26, 2008

Related U.S. Application Data
(60) Provisional application No. 60/960,445, filed on Sep. 28, 2007.

(51) Int. Cl. E21F 11/00; C01B 13/02

(52) U.S. Cl. 62/260; 62/125; 423/579

(57) ABSTRACT

An atmosphere handling system for use in a confined atmosphere is disclosed having an oxygen generator for generating oxygen from a stored release agent, an air conditioning system for cooling and re-circulating the air atmosphere, a desiccant module for filtering and removing moisture from the atmosphere and a power and operations system for powering and controlling the system.

This application claims the benefit of U.S. Provisional Application No. 60/960,445, filed on Sep. 28, 2007, the entire contents of which are incorporated herein by reference.

### BACKGROUND

The invention is related generally to atmosphere handlers, and more specifically to an atmosphere handler for maintaining a breathable atmosphere within an enclosure.

The mining industry is subject to distinct, inherent risk of extremely hazardous and sometimes fatal catastrophes occurring with little or no warning. Mining accidents account for many deaths each year. The risk of accident is particularly high in mining operations in China and in various developing countries. Causes of mining accidents vary widely, including seismic activity, underground pockets of poisonous gas, ignition of flammable gas, sudden flooding, dust explosions and collapsing shafts.

Facing an unexpected, life-threatening emergency, the miners nearest to the mining accident site may be unable to reach an exit of the mine. Accordingly, some mines include emergency pods which are installed within the mine and transported to remain proximal with working areas of the mine. An exemplary emergency pod is shown in U.S. Pat. No. 4,815,363.

When a situation arises wherein miners must escape to an emergency pod, the environment surrounding the pod may exhibit unhealthy atmospheric conditions. Exemplary conditions include poisonous gases, dense dust clouds, excessive smoke or other harmful environments. It is desirable for emergency pods to be provided with an atmosphere handling unit to efficiently provide breathable air for the occupants of the pod.

Existing emergency pods may provide cylinders of high-pressure oxygen gas which may be released to the confined atmosphere for a short period of time. Others may provide an “oxygen candle,” which is ignited and releases oxygen into the confined atmosphere for a short period of time. Each of these techniques, however, only introduces oxygen into the confined atmosphere. They do not provide a way remove toxic gases, such as carbon monoxide, or to remove water vapor and carbon dioxide produced from occupants' breathing.

### SUMMARY

The atmosphere handling system is a device which provides a breathable atmosphere for a confined enclosure. The system monitors the condition of the air within the enclosure and takes appropriate action to maintain a necessary level of oxygen while removing exhaled carbon dioxide and other gases from the atmosphere. The invention includes particular features tailored to the needs of an emergency pod located in an underground mine.

In one aspect, the atmosphere handling system includes a stored oxygen release agent which is used to sustain a breathable atmosphere within an enclosure over an extended period of time.

In another aspect, the atmosphere handling system includes a stored power supply which may be used to selectively power various components of the system in order to extend the length of operational time which the system may sustain viable operations.

In yet another aspect, the atmosphere handling system includes a mechanism which may be powered by individual efforts to recharge the power storing elements of the system, thereby increasing the length of viable operational time of the system further.

In still another aspect, the atmosphere handling system includes components for filtering, cooling/heating and re-circulating air within the enclosure, removing undesirable elements from the air. These and other features and advantages of the invention will be more clearly understood from the following detailed description and drawings of preferred embodiments of the present invention.

### BRIEF DESCRIPTION OF THE DRAWINGS

FIGS. 1A and 1B are a schematic block diagram of a preferred embodiment of an atmosphere handling system according to the present invention.

FIG. 2 is a block diagram of the power and operations system of the atmosphere handling system of FIGS. 1A and 1B.

FIG. 3 is a block diagram of an alternate embodiment of the power and operations system of the atmosphere handling system of FIGS. 1A and 1B.

FIG. 4 is a block diagram of the oxygen generator of the atmosphere handling system of FIGS. 1A and 1B.

FIG. 5 is a block diagram of an alternate embodiment of the oxygen generator of the atmosphere handling system of FIGS. 1A and 1B.

FIG. 6 is a block diagram of the air conditioning assembly of the atmosphere handling system of FIGS. 1A and 1B.

FIG. 7 is a block diagram of an alternate embodiment of the air conditioning assembly of the atmosphere handling system of FIGS. 1A and 1B.

FIG. 8 is a block diagram of the desiccant module of the atmosphere handling system of FIGS. 1A and 1B.

FIG. 9 is a block diagram of an air filtering module of the atmosphere handling system of FIG. 14

FIG. 10 is a front view of the CO₂ scrubber used in the air conditioning assembly of FIG. 6.

FIG. 11 is a top view of the CO₂ scrubber used in the air conditioning assembly of FIG. 6.

FIG. 12 is a cross-sectional view of the CO₂ scrubber view taken along line X-X of FIG. 11.

FIG. 13 is a front view of an alternate embodiment of the CO₂ scrubber of FIG. 11 in an alternate orientation.

FIGS. 14A and 14B are a schematic block diagram of an alternate embodiment of an atmosphere handling system according to the present invention.

### DETAILED DESCRIPTION

In the following detailed description, reference is made to the accompanying drawings which form a part hereof, and in which are shown by way of illustration preferred embodiments of the invention. These embodiments are described in sufficient detail to enable those skilled in the art to make and use them, and it is to be understood that structural, logical or procedural changes may be made.

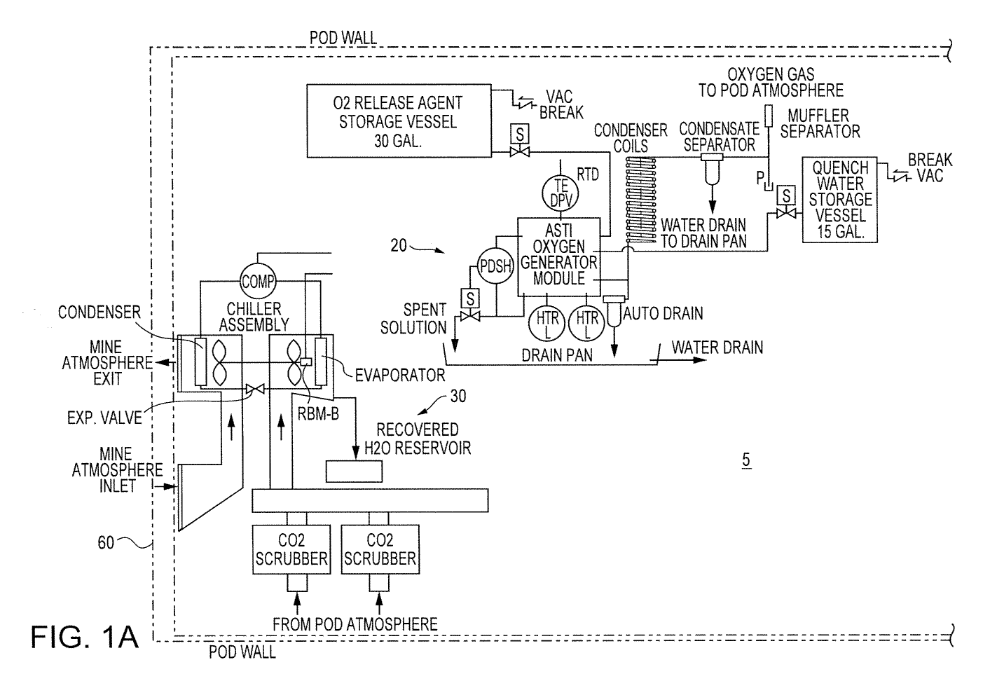

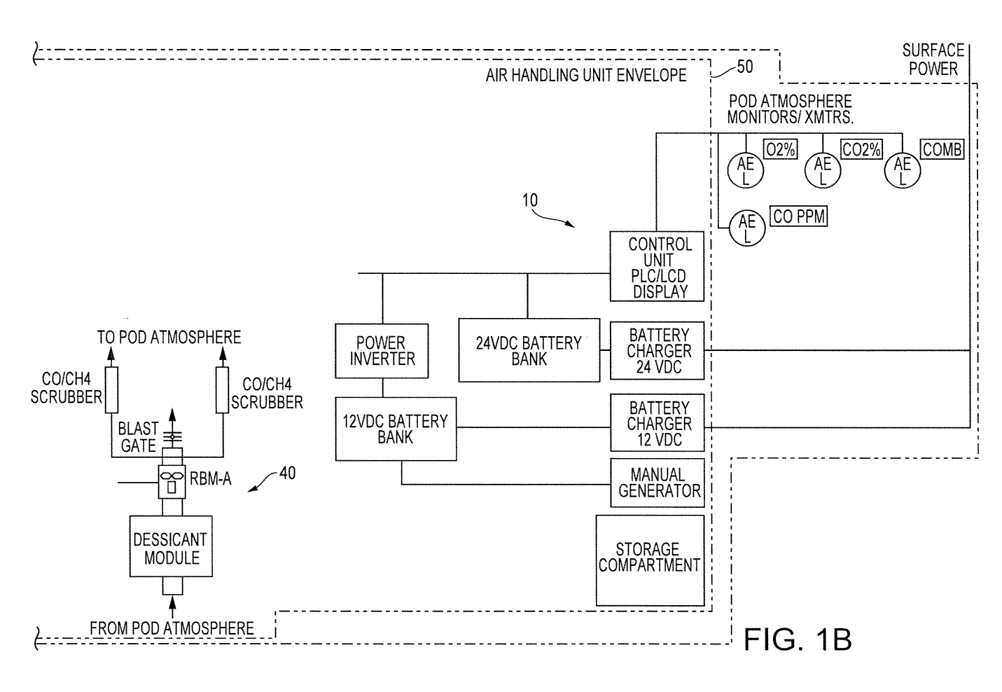

Referring first to FIGS. 1A and 1B, an atmosphere handling system 5 according to the present invention includes a power and operations system 10, an oxygen generator 20, an air conditioning assembly 30, and a desiccant module 40. Although these elements are illustrated as contained within a single air handling unit envelope 50, they may also operate in separate compartments disposed in various locations within a pod enclosure 60 or otherwise integrally incorporated into the pod 60 structure. Part for air cooling and part for air handling.

A suitable pod 60 is described in U.S. patent application Ser. No. 11/711,800. The pod 60 is preferably portable, having a frame of a size capable of comfortably accommodating a number of individuals and comprising walls providing a substantially airtight interior.

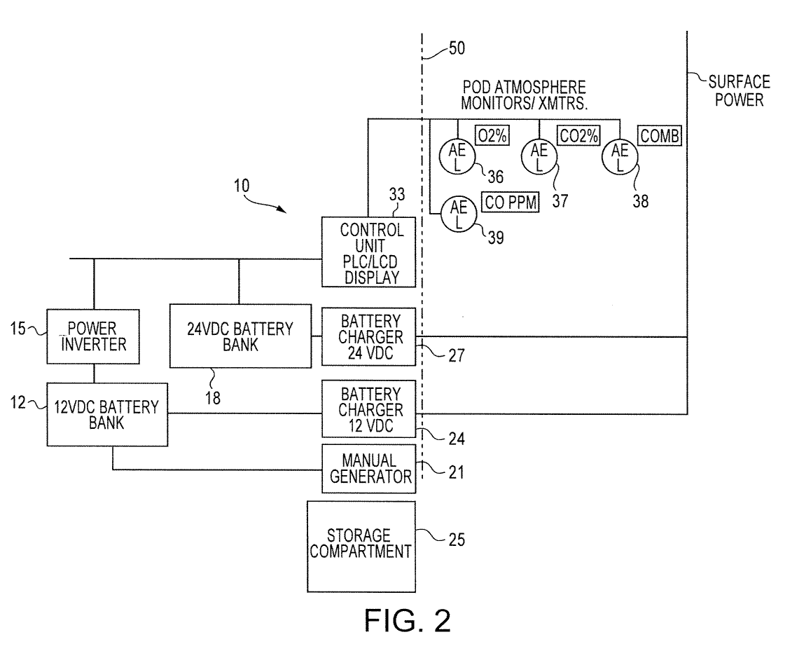

FIG. 2 shows the power supply and operations system 10 of the illustrated embodiment, hereinafter referred to as “power supply system,” which provides power for the atmosphere handling system 5 and controls various automated features. The power supply system 10 preferably includes a 12V DC battery bank 12, a power inverter 15, a 24V DC battery bank 18, a manual generator 21, a 12V DC battery charger 24, a 24V DC battery charger 27, atmospheric analyzer elements 36-39 and a control unit programmable logic controller (PLC)/LCD and/or personal computer (PC) based display 33 (hereinafter referred to as “control unit”).

The 12V DC battery bank 12 supplies power to the power inverter 15, which converts the DC power to AC power for AC-powered components of the atmosphere handling system 5, such as heaters and fans and/or blowers, as will be described below. The 24V DC battery bank 18 supplies power to the control unit 33, and may also be used to power other components used in the system. Both battery banks 12, 18 are connected to respective battery chargers 24, 27. The battery chargers 24, 27 may be supplied with power from an outside power source or surface power source, as indicated by the conductor line labeled “SURFACE POWER.” Alternatively, the 12V DC battery bank 12 may be charged using manual generator 21. The manual generator 21 may be, for example, a commercially available pedal generator, crank generator or other known manual power generator.

The control unit 33 controls operation of the oxygen generator 20, air conditioning assembly 30 and desiccant module 40 as will be described below. The control unit 33 includes a display, for example, an LCD monitor, and an input device, for example a keyboard or preferably a touch screen operator interface terminal (OIT), for relaying information to and accepting commands from occupants of the pod 60. The control unit 33 may also be equipped with an Ethernet or other network connection device for the purpose of allowing monitoring or control from a remote location.

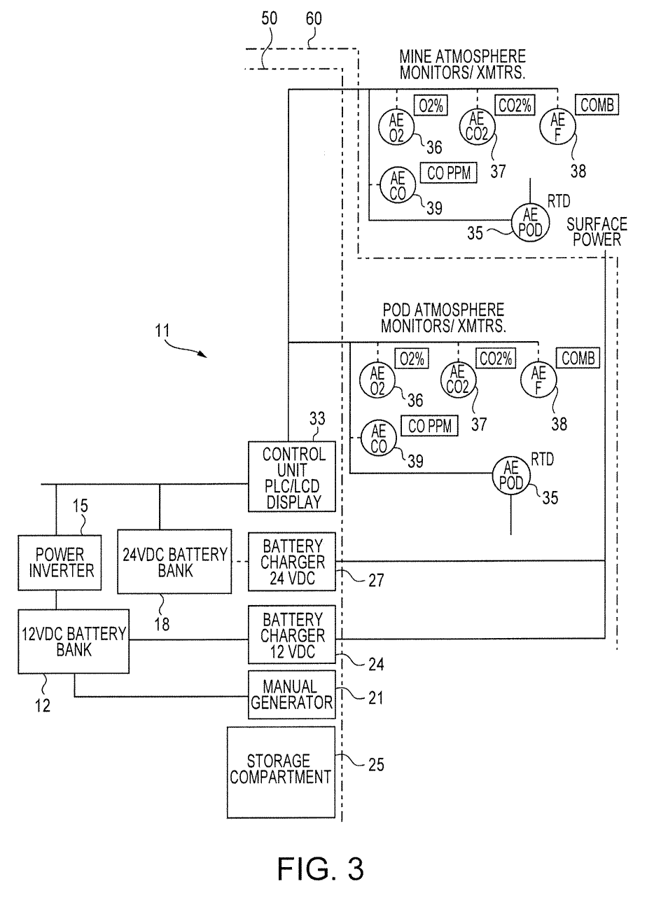

The control unit 33 is connected to analyzer elements 36-39, which are disposed outside of the air handler envelope 50 to monitor the atmosphere within the pod 60. The analyzer elements 36-39 (labeled “AE”) are preferably configured to monitor O₂ (36), CO (37), CO₂ (38) and combustible gases (39), however may be configured to monitor other gases or atmospheric conditions. Commercially available analyzer elements may be used. FIG. 3 shows an alternate embodiment of a power supply and operations system 11, including analyzer elements 35-39 to monitor the atmosphere both inside the pod and outside of the pod.

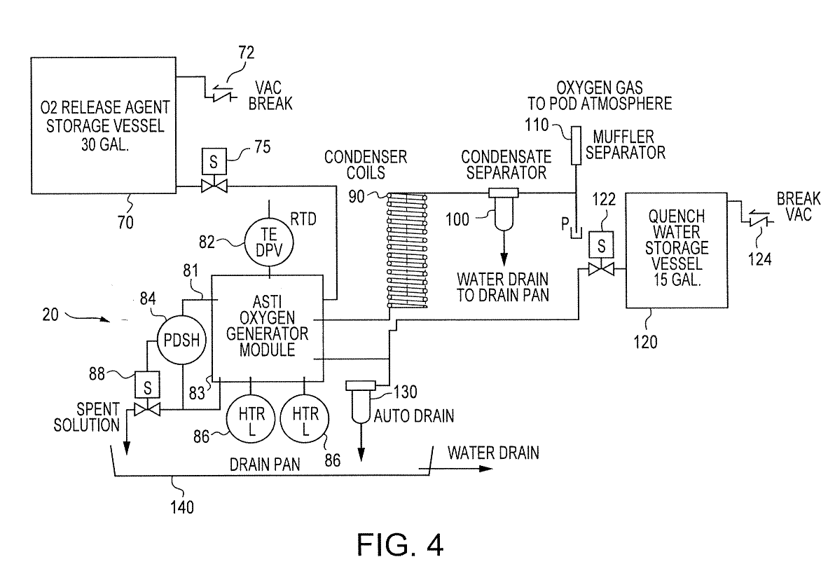

FIG. 4 shows the oxygen generator system 20 of the illustrated embodiment of the atmosphere handling system 5. Oxygen generator 20 preferably includes an oxygen release agent container 70 controllably connected to an oxygen production vessel 80, as well as condenser coils 90, a condensate separator 100, a quench water storage vessel 120 controllably connected to the oxygen production vessel 80, and a water drain pan 140. The oxygen generator 20 may optionally include a muffler 110 to stifle operation sounds and increase the comfort of the pod 60 occupants.

An oxygen release agent is stored in the release agent container 70. A preferred release agent is hydrogen peroxide (H₂O₂), 35-50% concentration in H₂O, but other suitable release agents may be used. The release agent container 70 volume is preferably about 30-100 gallons to ensure enough oxygen for up to 100 hours within a pod 60 containing 16 individuals, however, the volume may be more or less as needed according to the size and requirements of the pod 60. The release agent container is connected to a fill valve 75 and to a vacuum break valve 72. The fill valve 75, which is controlled by the control unit 33, controls the transfer of release agent from release agent container 70 to the oxygen production vessel 80. The vacuum break valve 72 appropriately relieves the vacuum within the release agent container 70 as the release agent is released.

The oxygen production vessel 80 includes a reaction catalyst, for example, copper tubing (not shown), predisposed within the oxygen production vessel 80. Heaters 86, controlled by the control unit 33, are attached to the oxygen generator module to heat the contents of the oxygen production vessel 80 during operation as required. A pressure differential switch high 84 (“PDSH”) monitors difference in pressure between a high location 81 and a low location 83 within the oxygen production vessel 80. A temperature element 82 monitors temperature within the oxygen production vessel 80 and relays the information to the control unit 33. The control unit 33 in turn controls a drain valve 88 for draining spent solution based on the lack of temperature rising within the oxygen module 80, which indicates the oxygen-production reaction has stopped and the oxygen agent is in the module 80 is spent.

Operation of the oxygen generator 20 will now be described. For the purpose of illustration, the release agent will be described as hydrogen peroxide. Upon start-up of the air control system 5 the control unit 33 opens the fill valve 75 to transfer hydrogen peroxide from the release agent container 70 to the oxygen production vessel 80. When the fill level reaches an appropriate level (dependant upon such factors as the release agent, the nature of the chemical reaction, the size of the oxygen production vessel 80), the control unit 33 closes the fill valve 75 and sends a signal to turn on heaters 86. The pressure differential switch high (“PDSH”) 84 monitors the fill level by comparing the differential pressure against a predetermined set value. The PDSH detects a pressure level near the top of the oxygen production vessel 80 and a pressure level near the bottom of the oxygen production vessel 80 and measures the difference between the two. The determined fill level information is communicated to the control unit 33. The oxygen production vessel 80 is preferably brought to a “standby state” by heating the oxygen release agent in the oxygen module 80 to a temperature which is less than but close to the temperature needed for an oxygen producing chemical reaction to take place. For example, using a hydrogen peroxide 35% concentration release agent, which decomposes at 140° F., a preferable standby state temperature is about 120° F. By maintaining the system at a standby state, the control unit 33 can operate the oxygen generator 20 to respond to oxygen needs more quickly than would be possible than starting the oxygen production process from ambient temperature.

The control unit receives information regarding the quality of air and the oxygen level in the atmosphere in the pod 60 from the analyzer elements 36-39 and controls the oxygen generator 20 to produce oxygen as needed to maintain a breathable atmosphere within the pod 60. When additional oxygen is needed, the control unit 33 sends a signal to the heaters 86, activating the heaters 86 to raise the temperature of the oxygen production vessel 80 to the reaction temperature of the release agent, shifting the oxygen generator from a standby state to a production state. At the reaction temperature, the hydrogen peroxide decomposes into H₂O and O₂. The oxygen passes out of the oxygen production vessel 80 and into the condenser coils 90 where water vapor is condensed into liquid form. The oxygen/water vapor mixture then passes into the condenser separator 100. The oxygen proceeds through the muffler 110 and is released into the pod 60 atmosphere. The condensed water is sent to a collection vessel 140 and/or released out into the mine.

The hydrogen peroxide decomposition process releases heat. If the temperature in the oxygen production vessel 80 becomes too high during the oxygen production process, the control unit 33 sends a signal to open water valve 122 to release quench water into the oxygen production vessel 80 from the quench water storage vessel 120. The quench water may be stored at ambient temperature and functions to lower the temperature of the solution in the oxygen production vessel 80. A vacuum break valve 124 operates to release the vacuum that forms within the quench water storage vessel 120 as quench water is released.

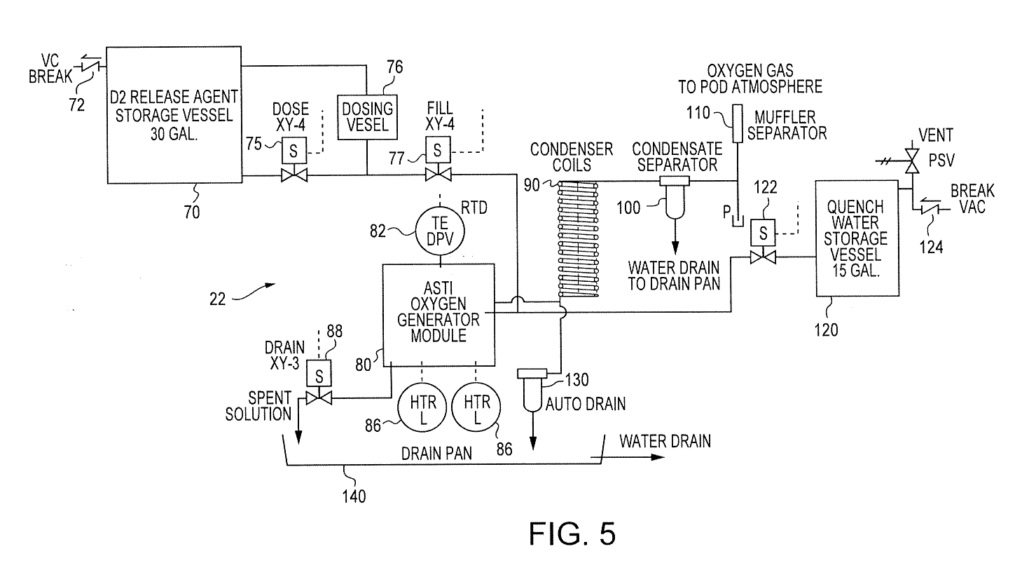

In an alternative embodiment, illustrated in FIG. 5. The PDSH 84 can be eliminated by utilizing a dosing vessel 76 to temporarily store a predetermined amount of release agent. In this embodiment, when the system 10 is first powered up, the control unit 33 opens solenoid valve 75. The solenoid valve 75 remains open for a period of time required to fill the dosing vessel 76, then closes and a signal is sent to the control unit 33. The control unit then opens solenoid valve 77, transferring the contents of the dosing vessel 76 to the oxygen production vessel 80. After the dosing vessel 76 has been emptied, solenoid valve 77 closes and the control unit immediately re-opens solenoid valve 75 to refill the dosing vessel 76 so that the process may be repeated when necessary. Simultaneously, the control unit 33 proceeds with the tasks described above in operating the oxygen production vessel 80, whether it be to adjust the temperature to bring oxygen production vessel 80 to a stand-by mode or immediately beginning the production of oxygen.

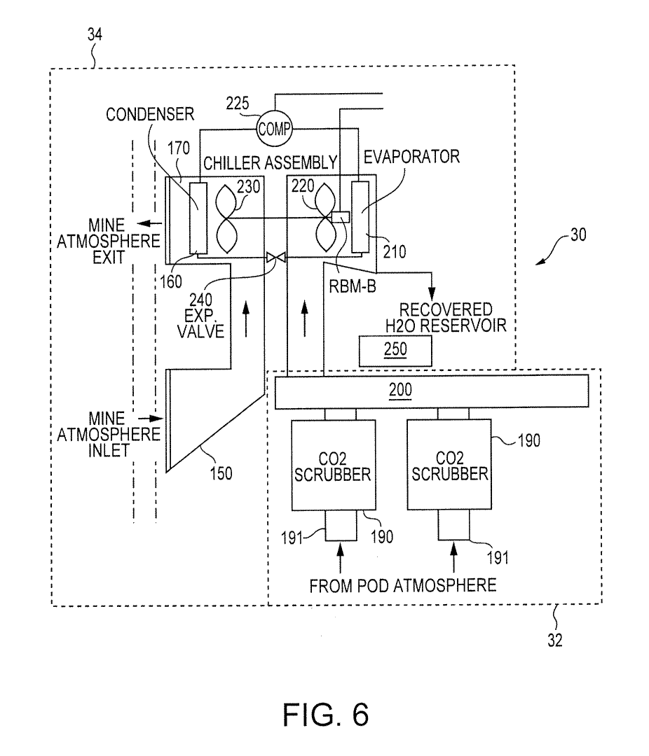

FIG. 6 shows a first embodiment of an air conditioning assembly 30 for cooling or heating and re-circulating the atmosphere within the enclosure. The air conditioning assembly 30 includes a filter portion 32 and a cooling/heating portion 34. The cooling/heating portion 34 includes an atmosphere inlet duct 150, an atmosphere outlet duct 170, a condenser 160, an evaporator 210, a compressor 225, an expansion valve 240, and a reservoir 250. The filter portion 32 includes a set of CO₂ scrubbers 190 having associated inlets 191, and an air duct 200 for transferring filtered air to the cooling/heating portion 34.

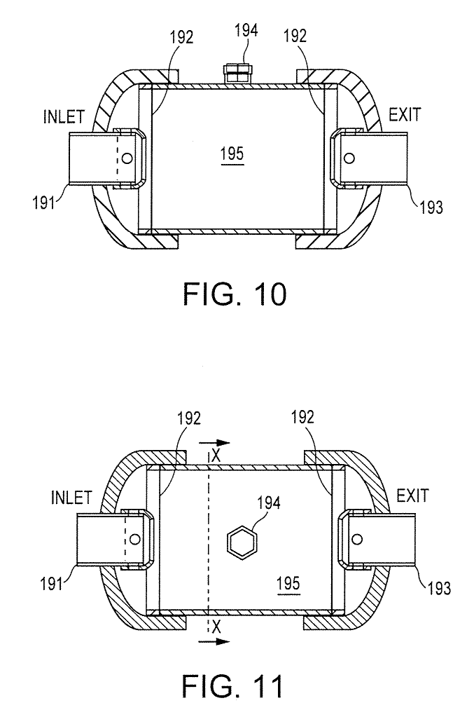

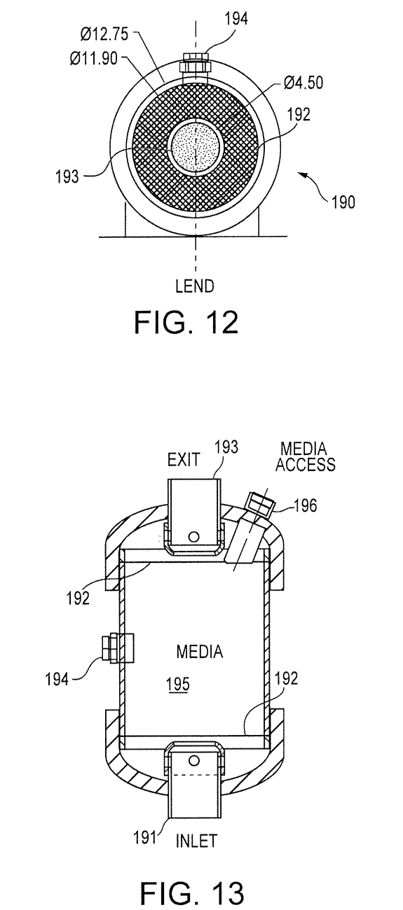

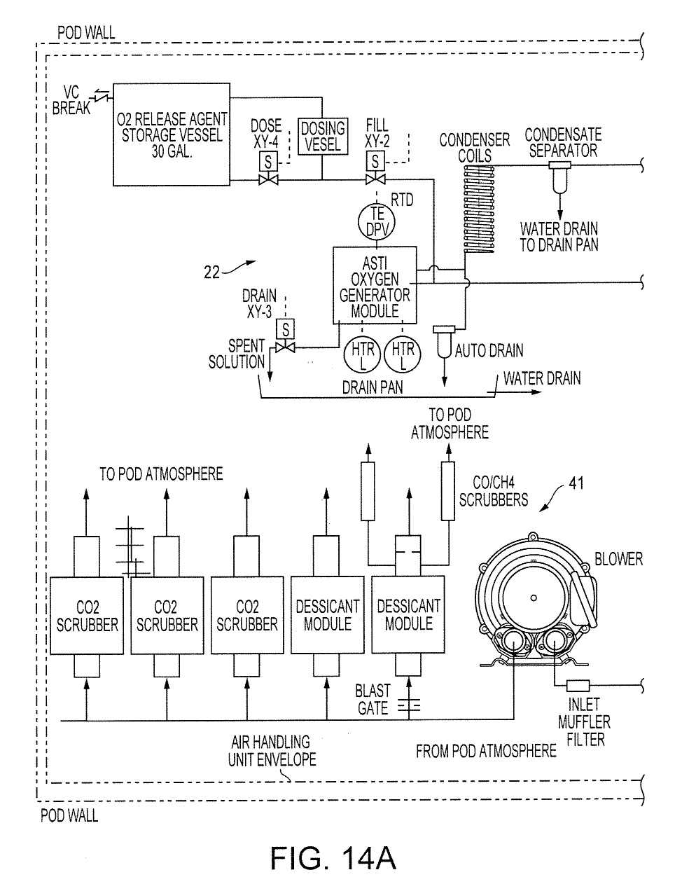

A fan 220 operates to draw in air from within the pod 60 through the CO₂ scrubbers 190 of the filter portion 32. Commercially available CO₂ scrubber chemicals, for example, Sodasorb from Smiths-Medical, 44#/KEG, 4-8 Grade CO₂ absorber, may be used. An exemplary CO₂ scrubber 190 is illustrated in FIGS. 10-13. Air is drawn in through an inlet 191 and passes through filters 192 and through an absorbent 195 before being drawn out through outlet 193. If a CO₂ scrubber 190 is positioned in a vertical orientation, as shown in FIG. 13, a media access port 196 is provided.

Referring back to FIG. 6, two CO₂ scrubbers 190 are shown, but more or fewer CO₂ scrubbers 190 may be included as necessary. Air filtered by the CO₂ scrubbers 190 passes through the air duct 200 and into the cooling/heating portion 34.

The first embodiment cooling/heating portion 34 uses a method similar to a standard refrigeration method for cooling air circulated back into the confined atmosphere. A compressor 225 compresses a refrigerant and transfers the compressed refrigerant into a condenser 160, where it is condensed into liquid form. A fan 230 draws in air from outside of the pod 60 through duct 150. The air passes over the condenser 160 and absorbs the heat released from the compressed refrigerant. The fan 230 blows the hot air out of the pod through outlet duct 170. The condensed, liquid refrigerant passes through an expansion valve 240 into an evaporator 210 having a lower pressure than the condenser 160. Once in the evaporator 210, the refrigerant evaporates. As the refrigerant evaporates, it draws in heat, thereby cooling the evaporator 210. Fan 220 draws the filtered air from the filter portion 32 is over the evaporator, thereby cooling the air, and blows the cooled air back into the pod 60 atmosphere. In another embodiment, a heat pump may be used to also provide heating if necessary. Moisture from water in the air condensing on the cooled evaporator 160 is drained into the reservoir 250.

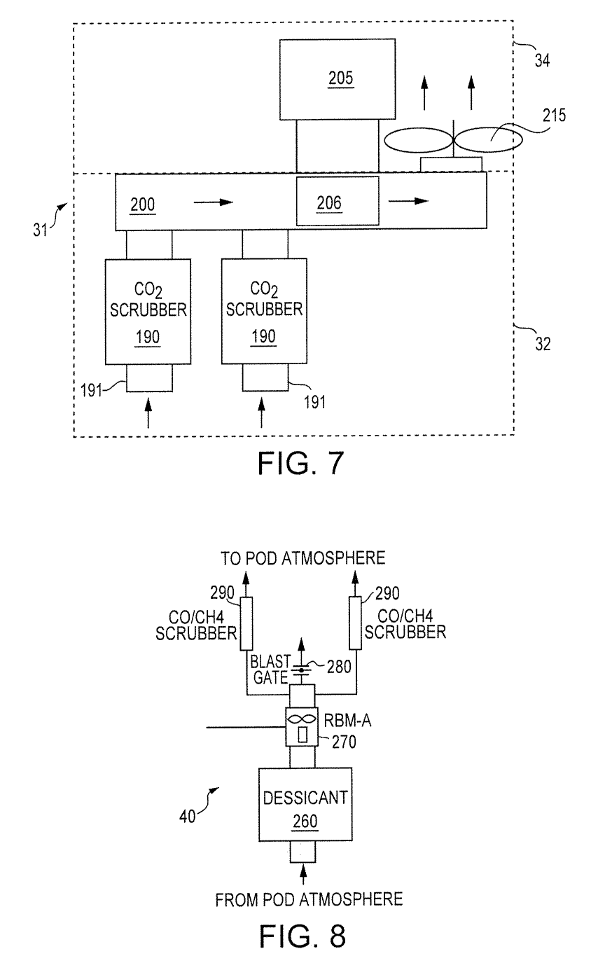

FIG. 7 shows an alternate embodiment for the air conditioning assembly 31. Air conditioning assembly 31 includes a filtering section 32 and a cooling section 34. The filtering section 32 comprises CO₂ scrubbers 190 and air duct 200, and operates as described above. The cooling section 34 comprises a water container 205, an ammonium nitrate container 206 and a fan 215.

The cooling section 34 operates by way of controlled release of water from the water storage container 205 into the ammonium nitrate container 205. The endothermic reaction of the ammonium nitrate with the water draws in heat and cools the surrounding atmosphere. When the fan 215 is turned on, air is drawn and/or blown past ammonium nitrate container 206 and cooled before being blown into the pod 60 interior. The ammonium nitrate container 206 may be configured to optimally allow passage of air to increase the efficiency of the cooling effect.

FIG. 8 shows a desiccant module 40. The desiccant module 40 provides additional filtering of the air within the pod 60, and includes a desiccant cartridge 260 for removing moisture from the air, a fan 270, a blast gate 280 and CO/CH₄ scrubbers 290. Upon activation of the desiccant module 40, the fan 270 is turned on and draws air from within the pod 60 through the desiccant cartridge 260. A commercially available desiccant media, such as, for example, Alumina, Ecompressed Air, #1AA18, 50#Bag, ⅛″ DIA Bead, 48#/FT3 may be used and will not be described further here. The blast gate 280 controls the direction of air that has passed through the desiccant cartridge 260. If the blast gate 280 is open, the air exits through the blast gate 280. If the blast gate 280 is closed, the air is sent through the CO/CH₄ scrubbers 290. Commercially available CO/CH₄ scrubbers may be used, such as, for example, Type 804 Faser Spolkaakcyjna and will not be described further here. The blast gate 280 is configured to be manually operable or configured to be controlled automatically by receiving signals from the control unit 33.

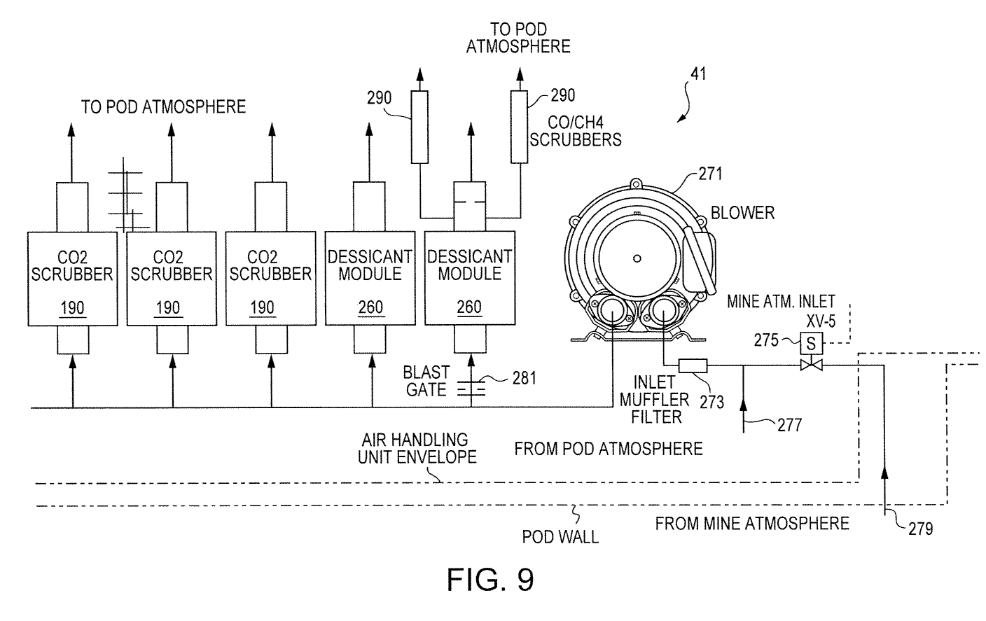

Alternatively, as shown in FIG. 9, the air conditioning assembly 31 may be omitted and the CO₂ scrubbers 190 combined with the desiccant module 40 to form an air filter system 41. The air filter system includes a blower 271, which draws in air from one of two inlets. A first inlet 273 draws air from within the pod 60. A second inlet 279 draws air from outside of the pod 60, that is, from the mine atmosphere. An inlet muffler 273 may be provided to decrease the operation noise for the comfort of the occupants. The control unit 33 operates solenoid valve 275 to control whether air is drawn from outside of the pod 60, depending on whether outside analyzer elements 35-39 (FIG. 3) indicate that the air outside of the pod is safe for use inside of the pod. In order to preserve the CO filters 290, control unit 33 operates a blast gate 281 to prevent air from passing through. Preferably, the system will attempt to remove water from the air before passing the air through the CO filters, as the CO media is consumed by both CO and water.

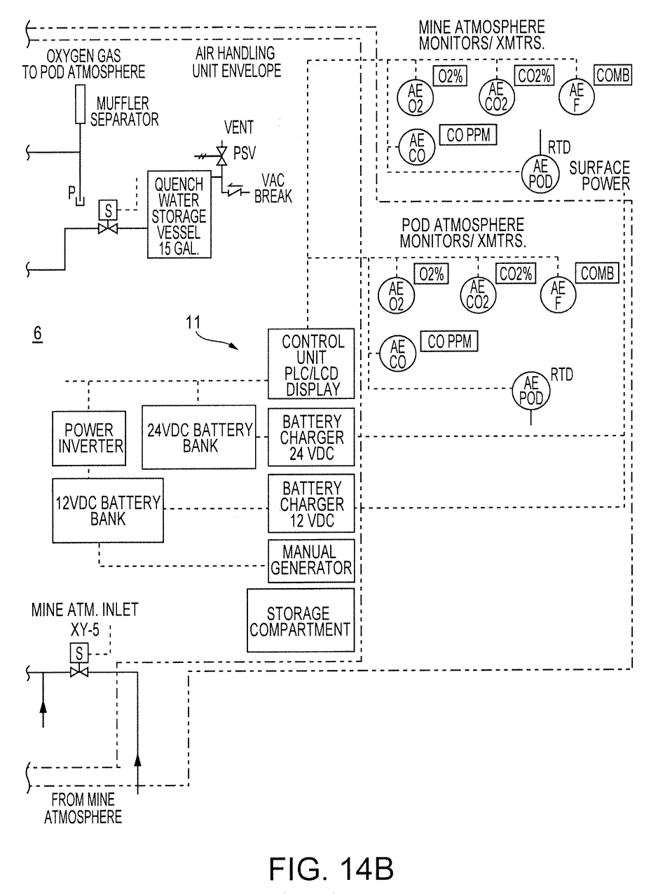

The air filter system 41 is shown in an embodiment of atmosphere handling system 6 illustrated in FIGS. 14A and 14B. This embodiment also includes oxygen generator 22 and power and control system 11. Although these particular components are shown illustrated, any combination of the components described above may be included.

Operation of the atmosphere handling system 5, hereinafter referred to as “the system,” will now be described. The system 5 is first installed or disposed within a confined atmosphere environment. Upon start-up of the system 5 the oxygen release module 20 is brought to a standby state, the desiccant module 40 is activated and the control unit 33 initiates monitoring of the volumetric composition of atmospheric gases within the confined atmosphere, preferably at least monitoring oxygen, carbon dioxide and carbon monoxide. Additional gases may be monitored as well, for example, combustible gases or any other gas or atmospheric condition as necessary. The levels of monitored gases may be stored at regular intervals and available for display to a user of the system 5 in the control unit 33. The stored data may be compiled to form a data history or log over time.

If it is determined that the volumetric composition of oxygen is lower than that of normal, breathable air, the oxygen release module 20 is switched to a productive state to produce oxygen until an appropriate level of oxygen within the confined atmosphere has been reached. Once the appropriate level has been reached, the oxygen release module is returned to a standby state. If it is determined that the atmosphere contains carbon monoxide, the system 5 notifies the user and closes the blast gate 280 in the desiccant module (FIG. 8) to send air through the CO/CH₄ scrubbers 290.

The temperature within the confined atmosphere is monitored by the system 5. A user may set a desired temperature for the atmosphere within the confined atmosphere using the control unit 33. The control unit operates the air conditioning assembly 30 to attempt to achieve the set temperature.

The control unit 33 may be programmed to prioritize operations for power conservation. In an exemplary conservation mode, production of oxygen as needed is a top priority, removal of carbon monoxide is a second priority, removal of other undesirable gases is a third priority and water removal and atmosphere temperature control is a fourth priority. Operations may be provided a percentage of the maximum operating power in accordance with priority. For example, first priority operations may receive 100% of maximum operating power, second priority operations may receive 80% of maximum operating power, and so on. Alternatively, operations that are non-essential for the system 5 to function may be executed in intervals of time proportional to their priority to conserve power.

Although the control unit 33 is described as operating many aspects of the system 5 automatically, the control unit 33 preferably includes a personal computer style interface (keyboard and screen) or a touch-screen operator interface terminal which is configured to provide the user with a menu-driven series of screens that allows for process monitoring, control, system setup, checkout and custom operation. Thus, the system 5 can run in a fully automated mode or a manually controlled mode. The control unit 33 is preferably configured to display system status as well as monitor reports on the monitor/touch-screen as well. When not in use, the system 5 may be programmed to run self-testing processes to check the system 5 capabilities, media/fluids level and other operational aspects. The results of the test may be stored as part of a data history similar to the in-use log described above.

In accordance with the above-provided description, an atmosphere handling system 5 may be configured to re-circulate and mix the atmospheric gases within a confined volume to produce and maintain a homogeneous mixture of gases therein and control the temperature within the confined volume. While the invention has been described in detail in connection with preferred embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention.

What is claimed as new and desired to be protected by Letters Patent of the United States is:

1. An atmosphere handling system for maintaining a breathable atmospheric condition within a confined atmosphere, comprising:
a power supply for providing power to system components;
a control unit for controlling operation of the system;
an oxygen generator for generating oxygen;
an air conditioning system for cooling or heating air and circulating the cooled or heated air within the confined atmosphere; and
a desiccant module for removing moisture from air within the confined atmosphere;
a filter for filtering air; and
a fan or blower for circulating filtered air within the confined atmosphere.

2. The atmosphere handling system of claim 1, further comprising one or more analyzer elements connected to the control unit for monitoring the volumetric composition of one or more gases in the confined atmosphere.

3. The atmosphere handling system of claim 2, wherein said gases include carbon monoxide, carbon dioxide, oxygen and combustibles.

4. The atmosphere handling system of claim 1, further comprising a manual power generator connected to the power supply for recharging the power supply.

5. The atmosphere handling system of claim 4, wherein the manual power generator is a pedal generator.

6. The atmosphere handling system of claim 1, wherein the power supply comprises:
a 12V DC battery bank;
an inverter connected to the 12V DC battery bank for converting the DC power to AC power;
a 12V DC battery charger;
a 24V DC battery bank; and
a 24V DC battery charger.

7. The atmosphere handling system of claim 1, wherein the air conditioning system comprises:
a filtering portion comprised of at least one CO₂ scrubber configured to receive air from within the confined atmosphere; and
an air temperature adjustment portion connected to receive air filtered through the filter portion, said air temperature adjustment portion being configured to adjust the temperature of the received air and circulate the air back into the confined atmosphere.

8. The atmosphere handling system of claim 7, wherein the air conditioning system is configured to cool the air circulated back into the confined atmosphere.

9. The atmosphere handling system of claim 7, wherein the air conditioning system is configured to heat the air circulated back into the confined atmosphere.

10. The atmosphere handling system of claim 1, wherein the control unit includes a touch-screen operator interface terminal.

11. The atmosphere handling system of claim 10, wherein the control unit configured to display system status and atmosphere monitoring reports on the touch-screen.

12. The atmosphere handling system of claim 1, wherein the oxygen generator comprises:
a stored volume of an oxygen release agent;
an oxygen generator module for receiving the oxygen release agent and housing the oxygen release agent during an oxygen releasing chemical reaction;
a quench water storage vessel for providing quench water to the oxygen generator module; and
at least one heater for controlling the temperature of the oxygen generator module.

13. The atmosphere handling system of claim 1, wherein the filter includes at least one CO scrubber.

14. The atmosphere handling system of claim 1, wherein the filter includes at least one CO₂ scrubber.

15. A atmosphere handling system, comprising:
a power supply;
a control unit connected to the power supply;
an oxygen generator connected to the power supply and the control unit;
an air conditioning system connected to the power supply and the control unit; and
a desiccant module connected to the power supply and the control unit.

16. The atmosphere handling system of claim 15, wherein the oxygen generator comprises:
a container storing a volume of an oxygen release agent;
an oxygen generator module connected to the oxygen release agent container;
a quench water storage vessel connected to the oxygen generator module; and
at least one heater connected to the oxygen generator module.

17. The atmosphere handling system of claim 15, wherein the power supply comprises:
a 12V DC battery bank;
an inverter connected to the 12V DC battery bank for converting the DC power to AC power;
a 12V DC battery charger;
a 24V DC battery bank;
a 24V DC battery charger; and
a manual power generator.

18. The atmosphere handling system of claim 17, wherein the manual power generator is a pedal generator.

19. A method of providing oxygen and controlling atmospheric conditions within a confined atmosphere using an atmosphere control system, comprising:
providing electrical power for the atmosphere control system;
monitoring the confined atmosphere to determine an oxygen level of the confined atmosphere;
operating an oxygen generator of the atmosphere control system to generate oxygen from an oxygen release agent;
monitoring the confined atmosphere to determine the presence of harmful gases;
filtering air within the confined atmosphere to remove moisture and harmful gases;
monitoring the temperature of the air within the confined atmosphere; and
operating an air conditioning system of the atmosphere control system to heat or cool the air to achieve a safe temperature for individuals within the confined atmosphere.

20. The method of claim 19, wherein the harmful gases includes CO, CO₂, and combustible gases.

21. The method of claim 19, wherein the electric power provided to the atmosphere control system is provided on a priority basis.

22. The method of claim 19, further comprising providing users of the atmosphere control system with data entry and receiving means for operating the atmosphere control system.

23. The method of claim 19, further comprising operating the oxygen generator automatically by via the atmosphere control system.

24. The method of claim 19, wherein operating the oxygen generator comprises:
setting the oxygen generator to a standby state;
switching the oxygen generator from a standby state to an oxygen-production state when the oxygen level is detected as being below a threshold level;
switching the oxygen generator back to a standby state when the oxygen level as reached the threshold level.

25. The method of claim 24, further comprising increasing the rate of production of oxygen in the oxygen generator by providing a chemical reaction catalyst to interact with the release agent.
